(19) United States
(12) Patent Application Publication
(10) Pub. No.: US 2020/0059461 A1
(43) Pub. Date: Feb. 20, 2020

(54) OPTIMIZATION OF AUTHENTICATION PROCESS

(71) Applicant: CA, Inc., New York, NY (US)

(72) Inventors: Chandra Sekhar Varanasi, Hyderabad (IN); Murali Krishna Segu, Hyderabad (IN); Vinay Kumar Tiruvaipeta, Hyderabad (IN); Jeetendra Gopal Varanjani, Hyderabad (IN)

(21) Appl. No.: 16/105,408

(22) Filed: Aug. 20, 2018

(51) Int. Cl. H04L 29/06

(52) U.S. Cl. CPC H04L 63/08; H04L 2463/082; H04L 63/105

(57) ABSTRACT

A secure protocol has been developed that reduces the number of transactions associated with multifactor authentication (MFA) systems. An identity provider determines authentication factors which satisfy an application assurance level and constructs a credential collection file with input elements corresponding to the determined factors. The identity provider communicates the file to a client for collection of corresponding credentials. After submission of credential data, the collected set of credentials or credential data (“MFA credential set”) is returned to the identity provider for verification. The identity provider does not redirect to the client for additional transactions until after verifying the MFA credential set. In addition to reducing MFA communication overhead for a client, the credential collection file is based on a structure or schema that can be edited to adapt to changes in assurance level and authentication mechanisms. This allows the protocol to be adapted to non-standard or custom authentication mechanisms.

### BACKGROUND

The disclosure generally relates to the field of information security, and more particularly to multicomputer data transferring.

Multifactor authentication systems increase security of the user authentication process by requiring a user requesting access to an application to first present multiple types of credentials. Credentials are verified before the user is granted access to the application. Requested credentials belong to different categories of authentication factors. A service provider can set an assurance level that is associated with a set of credentials required to access an application.

An identity provider presents a client with a credential to collect from the user. The client collects the corresponding credential from the user and submits the credential to the identity provider. The identity provider sends the user credential to a provider associated with the credential type for verification. This process repeats for each of the credential types designated by the service provider assurance level. The user request to access the application is granted upon successful verification of each credential.

### BRIEF DESCRIPTION OF THE DRAWINGS

Embodiments of the disclosure may be better understood by referencing the accompanying drawings.

FIG. 1 is a conceptual diagram depicting a user authentication protocol for efficient credential collection according to an application assurance level.

FIG. 2 is a flowchart of example operations for file-based consolidation of credential collection for multi-factor authentication.

FIG. 3 is a flowchart of example operations for creating a credential collection file.

FIG. 4 is a flowchart of example operations for client-side processing of a credential collection file by an authentication agent.

FIG. 5 depicts an example computer system with a file generator which creates a file to use for credential collection, submission, and verification in a user authentication protocol.

### DESCRIPTION

The description that follows includes example systems, methods, techniques, and program flows that embody aspects of the disclosure. However, it is understood that this disclosure may be practiced without these specific details. In other instances, well-known instruction instances, protocols, structures and techniques have not been shown in detail in order not to obfuscate the description.

Overview

Multifactor authentication (MFA) systems increase security of the user authentication process by requesting several different factors or credential types from a user for verification. However, each credential is requested, collected, and verified individually, resulting in one set of transactions for each credential. The number of transactions can grow exponentially with an increasing number of credentials.

A secure protocol has been developed that reduces the number of transactions associated with MFA systems. An identity provider server obtains a set of authentication factors associated with an application assurance level set by an application service provider. The service provider shares the assurance level with the identity provider without sharing the name of the specific application the user is attempting to access. The identity provider determines factors that satisfy the assurance level of the service provider and constructs a credential collection file with input elements corresponding to the determined factors. A user interface will prompt a user to input credentials according to the input elements. The identity provider communicates the credential collection file to a client which collects credentials for the factors indicated in the credential collection file. Once the user submits user credential data corresponding to the set of requested factors, the collected set of credentials or credential data (“MFA credential set”) is returned to the identity provider. After receiving the MFA credential set, the identity provider verifies each credential in the credential set. The identity provider does not redirect to the client for additional transactions until after verification of the MFA credential set. In addition to reducing the MFA communication overhead for a client, the credential collection file is based on a structure or schema that can be edited to adapt to changes in assurance level and changes in authentication mechanisms, such as new factors. This allows the protocol to be adapted to non-standard or custom user authentication mechanisms.

Example Illustrations

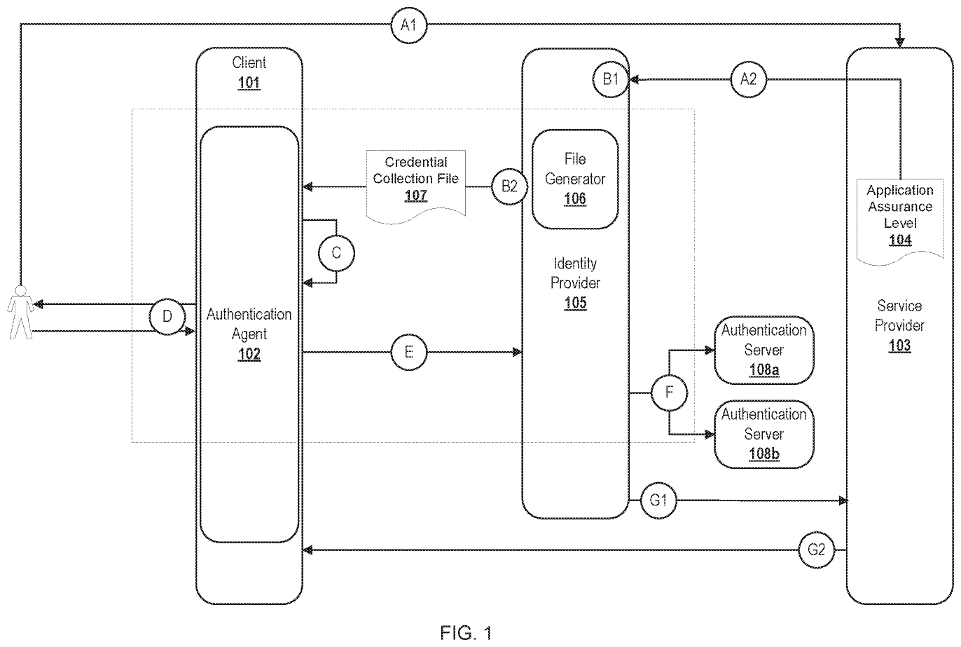

FIG. 1 is a conceptual diagram depicting a user authentication protocol for efficient credential collection according to an application assurance level. FIG. 1 depicts an application service provider 103 which receives a request to access an application utilizing an MFA method of authentication. The service provider 103 has an application assurance level 104 associated with the application. The application assurance level 104 can be mapped to a set of factors for which corresponding credentials should be collected for authentication prior to granting application access. The application assurance level 104 can be shared with an identity provider 105 to determine the set of credentials to collect. The credentials belong to different categories of factors, such as knowledge factors, possession factors, and inherence factors. Within each factor category, there is likely multiple types or subcategories of factors. For example, satisfying an assurance level may require an inherence factor and a knowledge factor. The knowledge factor category comprises a password subcategory and a self-knowledge subcategory, among others. The inherence factor category includes as a subcategory biometric identifier, which itself includes the subcategories of iris scans and fingerprints. These credentials are determined based on a mapping of the application assurance level 104 to a corresponding set of factors and/or factor subcategories. For example, the assurance level 104 may indicate that a credential corresponding to a factor subcategory of an inherence factor should be collected for authentication. The identity provider 105 can then determine that an iris scan satisfies the conditions of the assurance level.

A risk engine within an authentication risk server may calculate a risk score associated with accessing the application. If an application risk score has been calculated, the authentication risk server returns the risk score to the identity provider 105. The identity provider 105 may consider the risk score when determining the factors corresponding to the level of authentication desired. The identity provider 105 contains a file generator 106 which creates an extensible markup language (XML) credential collection file 107 indicating the set of factor subcategories for which corresponding credentials will be collected within the file content. After the identity provider 105 determines the set of factor subcategories based on at least one of the application assurance level 104 or the risk score, the file generator 106 constructs the credential collection file 107. In some embodiments, instead of generating a file after determining the set of credentials to collect, the application service provider 103 constructs and provides the credential collection file 107 to the identity provider 105. The file 107 may have been modified to accommodate changes to authentication mechanisms that may not be included based on the assurance level 104 alone. The file 107 facilitates an adaptive, flexible MFA mechanism.

The credential collection file 107 includes elements for each factor subcategory naming a credential to collect. Each factor subcategory element includes a child element for credential value. The value element is empty upon generation of the file 107 and will be populated after receiving credentials from input. Factor subcategory elements in the credential collection file 107 may further include a metadata or child element indicating if input of the corresponding credential is mandatory or optional. The credential collection file 107 is sent to a client 101 for collection of credentials from input. A client-side authentication agent 102 running on the client 101 parses the credential collection file 107 to determine credential collection mechanisms which will be presented for input of credentials. The authentication agent 102 may be a native application or a Java® ServerPage (JSP) in a browser using the client as its endpoint. Credentials are collected and submitted to the identity provider 105, which sends credential data contained within the file 107 to corresponding authentication servers for verification.

FIG. 1 is annotated with a series of letters A1-G2. These letters represent stages of operations, each of which may be one or more operations, that go into more detail than the preceding summary of FIG. 1. Although these stages are ordered for this example, the stages illustrate one example to aid in understanding this disclosure and should not be used to limit the claims. Subject matter falling within the scope of the claims can vary with respect to the order and some of the operations.

At stage A1, the client requests access to an application associated with an assurance level 104 indicating MFA. At stage A2, the service provider 103 redirects the request for application access to the identity provider 105 and shares the associated application assurance level 104 with the identity provider 105 that provides authentication services for the service provider 103. The redirected request for application access is treated as an authentication request by the identity provider 105. Alternatively, the service provider 103 can generate an authentication request based on the application request from the client 101. In that case, the service provider 103 generates the authentication request with user identifying information extracted from the application request from the client 101. The service provider 103 does not provide the identity provider 105 with information identifying the specific application to which access has been requested. Stages A1 and A2 occur prior to the implementation of the authentication protocol. The implementation of the authentication protocol is depicted by stages B1 through E.

At stage B1, the identity provider 105 determines the set of factor subcategories based on the application assurance level 104 as received in an XML file comprising the authentication request. Content of the authentication request XML file may denote a specific requested assurance level or a minimum requested assurance level. If the authentication request calls for a specific assurance level, the identity provider 105 selects a set of factor subcategories corresponding to the exact assurance level contained in the request XML file. If the authentication request indicates an assurance level with either an inclusive or exclusive minimum bound, the identity provider 105 may select from several possible sets of factor subcategories with an appropriate assurance level. For example, an authentication request containing <NotBelow>3</NotBelow> designates that the identity provider 105 should select a set of factor subcategories corresponding to an application assurance level of 3 or greater. An authentication request containing <Above>2</Above> designates that the identity provider 105 should select a set of factor subcategories corresponding to an application assurance level greater than but not equal to 2.

After the identity provider 105 selects a set of factor subcategories, the file generator 106 constructs an XML, credential collection file 107 for an authentication response. The file 107 is also constructed to contain an element for each factor subcategory in the set. Factor subcategory elements can contain child elements specifying further factor subcategories within the subcategory named by the element. For example, the file may contain a one-time password element and a biometrics element. The biometrics element may then contain child elements for each of fingerprint and iris scan categories of biometric data. Each factor subcategory element in the file 107 contains a child element with unpopulated content for the value of the credential which will be collected. Some credentials, such as credentials within the biometric factor subcategory, should be encrypted before they are sent to the identity provider in the file 107. If credential data input for a given factor subcategory should be encrypted, the factor subcategory element contains an additional child element indicating protection of the credential. When constructing the credential collection file 107, credentials to be encrypted will be identified, and a “protected” field will be included as a child element for the factor subcategory element in the file 107. The credential collection file 107 may also include additional child elements for each factor subcategory indicating if input of the credential is mandatory or optional.

If the file 107 contains optional factor subcategories, credentials should be provided for a subset of an optional set, where the optional set contains the factor subcategories which are designated as optional. If a factor subcategory element in the credential collection file 107 does not contain a child element indicating if input of the credential is mandatory or optional, input of the credential is mandatory as a default. If the identity provider 105 has received an application-specific credential collection file 107 from the service provider 103, the protocol bypasses the operations associated with determining a set of factor subcategories and creating a file for the set of factors subcategories depicted by stage B1.

At stage B2, the constructed credential collection file 107 containing elements indicating factor subcategories and any associated child elements is communicated to the authentication agent 102 at the client 101 for file parsing and interpretation. At stage C, the authentication agent 102 parses the credential collection file 107 at the client 101. The authentication agent 102 can interpret the file 107 locally by parsing the XML elements and determining how to populate a user interface with credential input fields corresponding to the factor subcategories named by elements in the file 107. Distinction between mandatory and optional input of credentials also occurs during stage C. While parsing file elements, if the authentication agent 102 identifies any factor subcategories containing a child element denoting that input of the credential is optional, the agent 102 will determine an optional set to present. The optional set indicates that credentials should be provided for at least a given number of options in the set. For instance, if the biometric factor subcategory element contains child elements for each of fingerprint and iris scan biometric data and the fingerprint and iris scan elements contain the optional child element, input of only one of the two credentials is necessary for authentication. A user is requested to provide either a fingerprint or iris scan. The user may still provide both credentials if desired. The user cannot be verified if neither of the options are provided.

At stage D, after parsing the credential collection file 107 and determining the associated input elements, the credential input fields determined to correspond to the factor subcategories indicated in the file 107 are displayed on an interface at the client 101 for input of credentials. Credentials are input for each of the credential input fields presented on the interface. If the authentication agent 102 determined that the credential collection file 107 indicated an optional set, the interface prompts for input of credentials for a subset of the optional set. The set of credentials is submitted in one batch after input has been provided.

Upon submission of credential data, the credential collection file 107 is populated with the credential data contained in the credential input fields. For each credential input field having input containing credential data, the credential data from user input is inserted as the content in the value child element for the factor subcategory element corresponding to the input field. If a factor subcategory element contains a child element indicating that the credential data is to be protected, the authentication agent 102 encrypts the credential data prior to storing the data in the credential collection file 107. Encryption key information is contained in the authentication response portion of the file 107. Once value elements in the credential collection file 107 are populated with values corresponding to the credential data named by the parent factor subcategory element, the authentication agent 102 sends the credential data contained within the file 107 to the identity provider 105 for verification of provided credentials at stage E.

After the identity provider 105 receives the XML file 107 containing the credential data from the client 101, the identity provider 105 iterates through the factor subcategory elements in the credential data contained in the file 107 and retrieves the credential data from the value elements or fields for each factor subcategory element. For each credential, the identity provider 105 connects with a corresponding authentication server for verification of the credential, identified as stage F. For example, if an authentication server 108a is a biometric server and a second authentication server 108b is a certificate authority, the identity provider 105 verifies each of the credentials corresponding to the biometric server and certificate authority separately. Verification of both credentials occurs prior to sending a response back to the client 101, assuming the two credentials are sufficient to satisfy the assurance level 104 communicated to the identity provider 105 for the application to which the client is attempting to access.

Stages G1 and G2 occur after credential verification. If credential verification failed in stage F, the identity provider 105 redirects to the client 101 with an authentication failure notification, and application access is not granted. If credential verification succeeded, at stage G1, the identity provider 105 returns a successful authentication response to the service provider 103. The service provider 103 grants application access in response to receiving the authentication success and redirects to the client 101 with application access at stage G2.

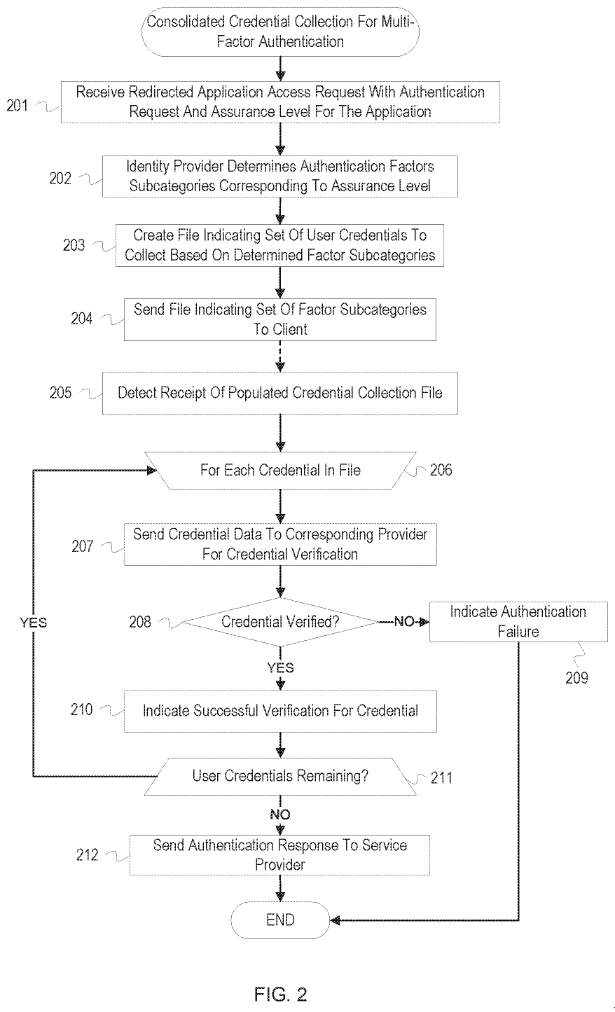

FIG. 2 is a flowchart of example operations for file-based consolidation of credential collection for multi-factor authentication. After a request to access an application which uses MFA is issued, a service provider receives the request. An identity provider receives the redirected request and an assurance level for the requested application from the service provider (201). The redirected request includes an authentication request with attributes of the request (e.g., service provider name, time of issue, destination, and URL of the consumer service). The authentication request also contains elements indicating the source which issued the request and a requested assurance level. The requested assurance level may be an exact value or a minimum value which includes or excludes the minimum bound.

After receiving the authentication request, the identity provider determines a set of authentication factors in accordance with the requested assurance level it has received (202). For example, if the service provider requests an assurance level of exactly 4, accessing the application is associated with a high level of assurance of authentication, and a hardware-based token should be used. The identity provider may select a set of factors corresponding to credentials to collect which includes a fingerprint scan in addition to a username and password. The identity provider may select from a catalogue of credential types available to the identity provider that satisfy the assurance level.

Once the set of factors has been determined, the identity provider creates a credential collection file to be sent to a client-side authentication agent (203). The file contains an authentication response in addition to elements indicating which factor subcategories have been selected for authentication. For each factor subcategory in the set, the identity provider constructs a file element/field labeled with the subcategory name. The identity provider adds a child element for the value of the corresponding authentication credential. The value child element is initially unpopulated. If the factor subcategory is indicated as mandatory or optional based on the conditions of the assurance level, the identity provider adds an additional child element indicating if input of the corresponding credential is mandatory or optional. The factor subcategory element may indicate that the credential should be encrypted before submitting the populated file to the identity provider. If the credential should be encrypted, the identity provider adds an encryption child element indicating that the value child element content should be protected.

The identity provider sends the constructed file containing the factor subcategories corresponding to credentials to collect to the authentication agent at the client (204). The identity provider determines the identity of the client from the request for application access redirected from the service provider. The identity provider should eventually detect receipt of a populated credential collection file corresponding to the one previously sent (205). The identity provider may leverage communication protocol session information to “remember” the client or maintain an internal data structure to track outstanding or in-flight credential collection files. The identity provider verifies the credentials contained in the populated value child elements. For each factor subcategory with credential data in the file (206), credential data populating the value child element is submitted to a corresponding authentication server for credential verification (207). Since the identity provider may be processing multiple credential collection files for various clients, the identity provider may maintain an internal state tracking structure per credential collection file if communication protocol information is insufficient or is not used. If the credential cannot be verified (208), the identity provider stores an indication that credential verification failed for the credential and/or the client (209). The identity provider communicates the failed verification event to the client, and application access is not granted. In some embodiments, the identity provider does not continue processing the file to verify remaining credentials after a first failed verification event. Otherwise, an indication is returned to the identity provider that the credential was successfully verified (210). The verification process repeats for each factor subcategory in the XML file (211).

Once credentials have been verified against the corresponding authentication servers, the identity provider updates the authentication response portion of the file to indicate an authentication success and redirects the authentication response to the service provider (212). The authentication response XML structure contains a status element and a tag indicating a status code. A value attribute corresponding to the status code tag is populated to indicate successful authentication. For example, the value attribute may be populated with “AuthSuccess,” and the service provider subsequently grants application access.

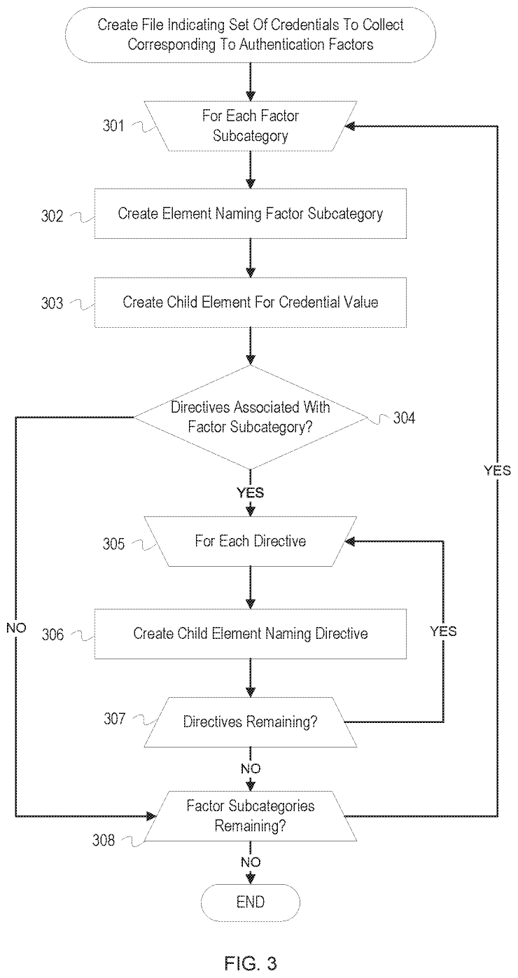

FIG. 3 is a flowchart of example operations for creating a credential collection file. For consistency with FIG. 1, the description refers to a file generator as performing the indicated operations. The file is generated after determining a set of authentication factor subcategories for which corresponding credentials will be collected. For each factor subcategory (301), the file generator creates an element naming the factor subcategory (302). A factor subcategory can contain additional subcategories. For example, a biometrics factor subcategory may contain iris scan and fingerprint subcategories. If the factor subcategory contains further subcategories, the file generator creates elements and child elements as described herein for each of the additional subcategories.

Once a factor subcategory element has been created, the file generator inserts a child element for the credential value corresponding to the factor subcategory (303). The value element is not populated until receiving a credential value from input. The file generator may add additional collection directive child elements for the factor subcategory. Example directives include whether a credential is mandatory or optional, if a credential should be encrypted, and a credential verification type. If there are directives associated with the factor subcategory (304), for each of the indicated directives (305), the file generator inserts a child element naming the directive (306). The directive child element may be populated with an indication that the directive should be applied to the credential corresponding to the parent element. For example, if data from a fingerprint scan is to be encrypted, the fingerprint credential file element may include the child element <Protected>Yes</Protected>. The directive will be identified while processing the file. The file generator constructs directive child elements until all directives have been reflected within the factor subcategory element (307). After constructing the content of a factor subcategory element, if there are remaining factor subcategories to include in the file (308), the file generator continues constructing the file content until each of the factor subcategories has been incorporated. The constructed file indicating the credentials to collect will be sent to an authentication agent at the client to be processed.

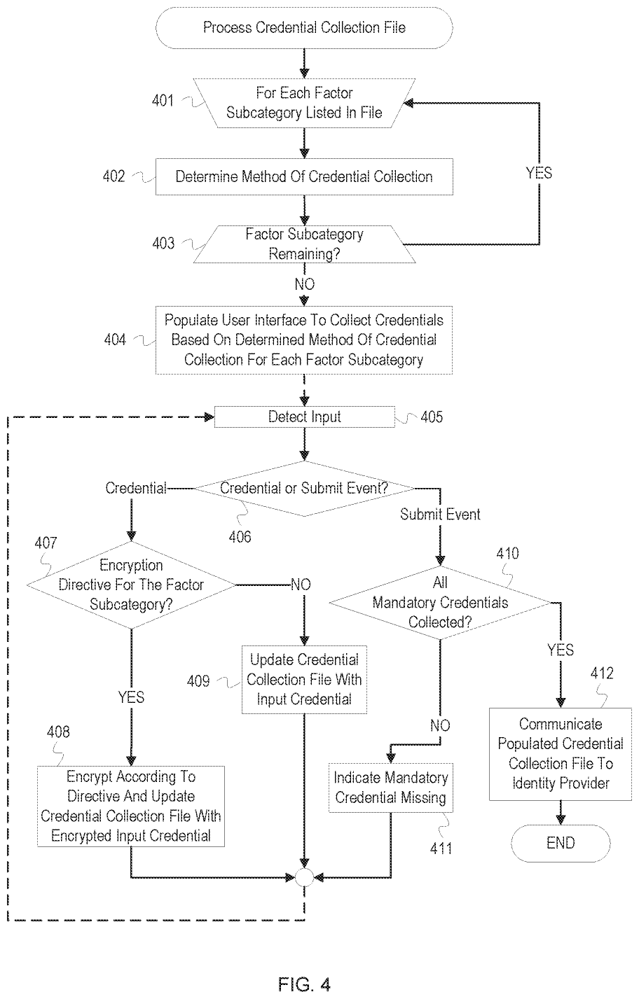

FIG. 4 is a flowchart of example operations for client-side processing of a credential collection file by an authentication agent. The file has been constructed by an identity provider and is organized with the structure described with reference to FIG. 3.

The credential collection file has a structure or schema designating both an authentication response and a set of authentication factor subcategories corresponding to credentials to collect from input. The authentication agent parses the file to determine which credentials will be collected and how the credentials should be requested and processed based on child elements within each factor subcategory element. For each factor subcategory element in the file (401), the authentication agent parses the element content to identify child elements and determine metadata/instructions/directives that indicate whether input is mandatory or optional, to be encrypted, etc. If input of a credential is optional, the authentication agent groups the factor subcategory within a set of subcategories for which credential input is designated as optional. During collection of credentials, an interface at the client will prompt for input of a predetermined subset of this optional set upon collection of credentials. For example, the optional set may contain two different biometric factors. A user will be prompted to provide credentials for one of the two biometric factors. In another example, the optional set may include a biometric factor and a national identification card. The user will be instructed to provide either a biometric credential or a national identification card to satisfy the optional set. If no mandatory or optional child elements are present, input of credentials corresponding to each factor subcategory in the file is considered to be mandatory.

In an embodiment, the application provider can modify the XML file structure to include an additional child element indicating a credential verification type. If the verification type indicates that client-side verification is supported, such as a type named “ClientSide,” the authentication agent can verify the credential at the client. In this case, the credential data will not be sent to the identity provider or authentication server for verification. For example, the authentication agent may verify biometric credentials at the client if the credentials are of a client-side verification type. The presence of credential verification type child elements will be confirmed during parsing of the credential collection file.

Once child elements have been parsed, the authentication agent determines a method of credential collection corresponding to the factor subcategory (402). Credential collection methods may be software-based or hardware-based. If the collection method is software-based, such as input of a username and password, the authentication agent determines the credential input fields which will populate a user interface (UI) at the client when credentials are collected. If the collection method is hardware-based, such as collection of a fingerprint scan, the authentication agent determines that an input field will not be displayed and to instead display a prompt for credential input using the appropriate hardware-based collection mechanism. If the file contains additional factor subcategory elements to be parsed (403), the authentication agent continues parsing the file and determining credential collection elements for the remaining factor subcategories.

Once the file has been parsed and collection methods have been determined, the UI is populated to collect credentials based on the determined credential collection methods for each factor subcategory (404). Software-based collection methods are displayed on the UI as user input elements with a prompt. For hardware-based collection mechanisms, the UI displays a prompt to input the appropriate credential into the corresponding hardware collection mechanism. If the authentication agent created an optional set, collection methods corresponding to the factor subcategories in the optional set will be grouped together. The UI will prompt for input for a given number or selection of the optional set.

After the UI has been populated for collection of credentials, the client awaits input. After input has been detected (405), the client determines if the input is a credential or a submit event (406). The determination is based on detection of input into a credential input element on the UI or an instruction to submit credentials which have been input, such as through selection of a submit option on the UI. Credentials from input are stored in a value child element for each factor subcategory in the credential collection file. If the client detects input of a credential, the authentication agent identifies if the factor subcategory corresponding to the credential contained an encryption directive (407). The encryption directive would have been identified during parsing of factor subcategory elements. If the factor subcategory contained an encryption directive, the credential is encrypted according to the directive (408). Encryption keys are contained within the structure of the credential collection file. The value child element of the corresponding factor subcategory within the credential collection file is updated to store the credential data after encryption according to the directive. If an encryption directive was not present, the credential collection file is updated with the input credential (409). The value child element of the corresponding factor subcategory is populated with the credential value as input into the UI. Once the file has been populated to include the value of the credential, the client continues to await additional input for credential or submit processing.

If the client detects a submit event, the authentication agent reviews the credential collection file to check for collection of mandatory credentials (410). The file should contain credential values populating the value child element for each mandatory credential as determined during file processing. If a mandatory credential was not provided prior to submission, the UI displays an indication that a mandatory credential is missing (411). The UI prompts for input of the missing mandatory credential to be provided before the file can be submitted to the identity provider, and the client re-enters the input detection loop at block 405. Otherwise, if each mandatory credential has been collected and the corresponding value child element is populated, the populated credential collection file is returned to the identity provider (412). The identity provider obtains the populated file for verification of credentials contained within the file. If the file contained a factory subcategory with a credential verification type child element indicating that a credential could be verified at the client, the authentication agent verifies the credential prior to communicating the file to the identity provider.

Variations

The above example illustrations refer to an application service provider granting application access as a result of successful user authentication. However, after the authentication success, the user may request access to a second application from the application service provider which is associated with a higher application assurance level. After receiving the request to access the second application, the service provider may grant application access with limited functionality based on the previous authentication or the service provider may not grant access. The authentication process repeats in accordance with the protocol described by the example illustrations for further authentication indicated by the assurance level. The service provider can open the remaining application functionality or grant application access upon receiving indication of an authentication success.

The examples often refer to a “file generator.” The file generator is a construct used to refer to implementation of functionality for constructing an XML file for communication of authentication factors and authentication credentials. This construct is utilized since numerous implementations are possible. A file generator may be a particular component or components of a machine (e.g., a particular circuit card enclosed in a housing with other circuit cards/boards), machine-executable program or programs, firmware, a circuit card with circuitry configured and programmed with firmware, etc. The term is used to efficiently explain content of the disclosure. The file generator can also be referred to as a file constructor. Although the examples refer to operations being performed by a file generator, different entities can perform different operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, with respect to FIG. 2, each operation depicted by the loop in blocks 206-211 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

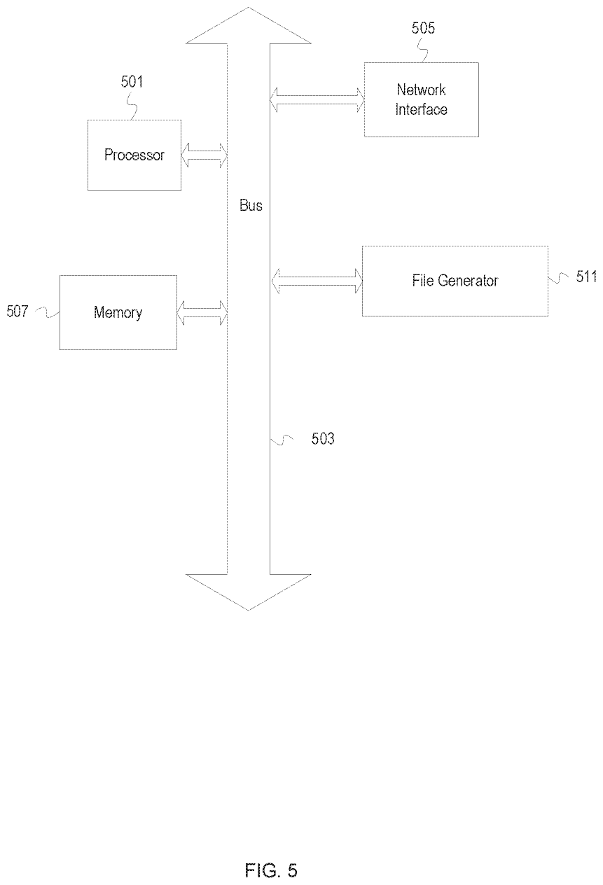

FIG. 5 depicts an example computer system with a file generator. The computer system includes a processor 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes a file generator 511. The file generator 511 constructs a file indicating a set of user credentials to collect in response to receiving an authentication request. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for file-based credential collection based on an assurance level as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on an assurance level for accessing an application offered by an application service provider, determining a first plurality of identity authentication factors that satisfy the assurance level;
constructing a file that indicates a credential type to be collected for each of the first plurality of identity authentication factors and indicates collection directives;
based on a redirected request to access the application, communicating the file to a client corresponding to the redirected request;
based on receipt of the file populated with credentials, verifying the credentials for a user identity corresponding to the redirected request; and
based on successful verification of the credentials, communicating successful verification of the credentials for the user identity to the application service provider.

2. The method of claim 1 further comprising determining the assurance level for accessing the application as communicated by the application service provider.

3. The method of claim 2, wherein the assurance level anonymously indicates the application corresponding to the redirected request.

4. The method of claim 1, wherein determining the first plurality of identity authentication factors comprises selecting from a catalogue of available identity authentication factors.

5. The method of claim 1, wherein the collection directives for a first of the plurality of identity authentication factors comprise at least two of a directive to protect a credential of the first identity authentication factor, a directive indicating whether a credential of the first identity authentication factor is optional, a directive specifying an input element for collecting a credential of the first identity authentication factor, and a directive indicating that a credential of the first identity authentication factor is to be verified at a client.

6. The method of claim 1, wherein verifying the credentials comprises communicating with one or more authentication services based on types of the credentials.

7. The method of claim 1 further comprising determining from the redirected request a network address to communicate the file to the client.

8. The method of claim 1 further comprising determining that the assurance level is a threshold assurance level, wherein determining the first plurality of identification factors comprises selecting a first set of identity authentication factors that satisfy the assurance level and a second set of identity authentication factors that exceed the assurance level, wherein the first plurality of identity authentication factors comprises the first and the second sets of identity authentication factors.

9. The method of claim 1 further comprising determining at least one credential type for each of the first plurality of identity authentication factors.

10. The method of claim 9, wherein constructing the file comprises constructing the file with one or more collection directives for a first identity authentication factor of the plurality of identity authentication factors, the one or more collection directives indicating that at least one of multiple credential types for a first factor of the first plurality of identity authentication factors is required to satisfy the assurance level.

11. The method of claim 1 further comprising communicating to the client failed verification based on failed verification of at least one of the credentials.

12. A non-transitory, computer-readable medium having instructions stored thereon that are executable by a computing device to perform operations comprising:
based on receipt of a credential collection file corresponding to an application access request, parsing the credential collection file to determine a plurality of credential types to collect;
updating a user interface with input elements to accept credentials of the plurality of credential types;
populating the credential collection file with the credentials collected based on the input elements; and
communicating the populated credential collection file to an identity provider that sent the credential collection file.

13. The non-transitory, computer-readable medium of claim 12, wherein parsing also comprises parsing the credential collection file to determine directives governing credential collection.

14. The non-transitory, computer-readable medium of claim 13, wherein the operations further comprise determining, based on the directives, a first subset of the plurality of credential types that are mandatory and a second subset of the plurality of credential types that are optional.

15. The non-transitory, computer-readable medium of claim 13, wherein the operations further comprise encrypting, based on a first of the directives for a first of the plurality of credential types, a first credential collected for the first credential type, wherein populating comprises populating the file with the encrypted credential.

16. The non-transitory, computer-readable medium of claim 12, wherein populating the credential collection file comprises populating child elements of the credential collection file with the collected credentials, wherein the credential collection file comprises hierarchically structured elements comprising parent elements for the credential types.

17. An apparatus comprising:
a processor; and
a machine-readable medium having program code executable by the processor to cause the apparatus to,
based on an assurance level for accessing an application offered by an application service provider, determine a first plurality of identity authentication factors that satisfy the assurance level;
construct a file that indicates credential types to be collected for the first plurality of identity authentication factors;
communicate the constructed file to a client that requested access to the application;
based on receipt of the file populated with credentials, traverse the populated file to verify the credentials; and
based on successful verification of the credentials, communicate successful verification of the credentials to the application service provider.

18. The apparatus of claim 17, wherein the program code to construct the file comprises program code to construct the file with collection directives that specify whether a credential type is optional for collection.

19. The apparatus of claim 17, wherein the program code to construct the file comprises program code to construct the file with a collection directive that specifies whether to protect a credential.

20. The apparatus of claim 17, wherein the program code to traverse the populated file to verify the credentials comprises program code to traverse the populated file until a credential fails verification.
